(19) United States
(12) Patent Application Publication
(10) Pub. No.: US 2002/0080810 A1
(43) Pub. Date: Jun. 27, 2002

(54) Packet concatenation method and apparatus

(76) Inventor: Eduardo Casais, Espoo (FI)

Correspondence Address: ALTERA LAW GROUP, LLC, 6500 CITY WEST PARKWAY, SUITE 100, MINNEAPOLIS, MN, 55344, US

(21) Appl. No.: 09/906,377

(22) Filed: Jul. 16, 2001

Related U.S. Application Data
(63) Continuation of application No. PCT/EP99/00213, filed on Jan. 15, 1999.

(51) Int. Cl. H04L 12/28

(52) U.S. Cl. 370/428; 370/389

(57) ABSTRACT

A method and apparatus for concatenating data packets in a communication protocol is described, wherein a connection to be used for concatenation is allocated to a memory region based on which data packets received from said connection are stored in order to be concatenated. Furthermore, an activity information of the connection is provided, wherein the allocation of the connection is changed on the basis of the activity information. Thus, a cache of connections which are deemed suitable for concatenation can be managed by shifting and cancelling the memory regions allocated to the connections so that active connections which actually utilize concatenation are kept in the cache, while other connections which do not need the concatenation feature are purged from the cache. Thereby, a restriction can be placed on the number of connections that can take advantage of the concatenation, so as to limit the overhead produced by the concatenation feature.

### FIELD OF THE INVENTION

The present invention relates to a method and apparatus for concatenating data packets in a communication protocol.

### BACKGROUND OF THE INVENTION

In a communication protocol, a higher and a lower communication layer may be provided according to the OSI (Open Systems Interconnection) layer model, each one implementing peer-to-peer communication facilities. Between the peers, data packets, e.g. Packet Data Units (PDUs), are transmitted, which typically contain a protocol control information, i.e. a header, a trailer, an identifier, a check-sum etc., and a payload containing user information.

In a situation where the PDUs of the higher communication layer are smaller than the PDUs of the lower communication layer, concatenation can be performed by grouping several packets of the higher communication layer into the payload portion of one packet sent by the lower communication layer. This is advantageous in that the transmission of one large packet is usually more efficient in terms of bandwidth usage and transmission overhead than the transmission of several small packets, especially if the size of the basic packet in the lowest communication layer is fixed.

The concatenation procedure is performed as follows:

The size of the packets handled by the lower communication layer is known by the higher communication layer. Thus, the higher communication layer buffers the PDUs to be sent to its peer until they fill the size of a packet in the lower communication layer. Accordingly, the transmission of the packets is delayed by the higher communication layer until they can be grouped and transmitted in one block in one packet of the lower communication layer.

To avoid indefinite transmission delays, a timer may be set in the higher communication layer. When this timer expires, the higher communication layer passes the PDUs it has collected so far to the lower communication layer, without waiting any longer until the packet of the lower communication layer is entirely filled.

At the other connection end, the peer must perform a separation of the concatenated data packets.

However, concatenation entails some overhead, because timers and additional buffers have to be provided. Moreover, the provision of the timers and additional buffers may be useless for certain connections, which exchange packets infrequently. In such cases, the timers in the higher communication layer will almost always expire before enough PDUs have been collected to fill a packet in the lower communication layer. Thus, in case one server has to handle hundreds of thousands or perhaps millions of clients, the aggregated overhead to handle concatenation might be unbearable, especially as regards timers which require event queues with real-time constrains and buffers which require memory space.

Additionally, the timers for flushing the concatenation buffers may slow down the connection and cancel the increased throughput provided by concatenation, if their time period is set too long.

A possible way to handle concatenation of PDUs would be for an application program using the top-level communication layer to explicitly instruct that layer when to start and when to stop collecting packets to be concatenated. However, such an approach makes the concatenation process dependent from the specific application using the communication protocol, and requires the application to become aware of details of the underlying communication layers.

### SUMMARY OF THE INVENTION

It is therefore an object of the present invention to provide a method and apparatus for concatenating data packets, by means of which overhead and delay can be reduced.

This object is achieved by a method for concatenating data packets in a communication protocol, comprising the steps of:

allocating a connection to be used for concatenation to a memory region;

storing data packets received from said connection on the basis of said allocation;

providing an activity information of said connection; and

changing the allocation of said connection on the basis of said activity information.

Additionally, the above object is achieved by an apparatus for concatenating data packets in a communication protocol, comprising:

memory means having a plurality of memory regions;

control means for allocating a connection to one of said plurality of memory regions, said one of said plurality of memory regions being used for concatenating data packets of said connection; and

providing means for providing an activity information of said connection, wherein said control means is arranged to change the allocation of said connections based on said activity information.

Accordingly, the number and/or position of connections in the memory means can be adapted dynamically according to the actual load situation by changing the allocation of the connections to the memory regions. Thereby, active connections actually utilizing concatenation are kept in the memory, while connections which do not need the concatenation feature are shifted to memory regions indicating a low activity and/or purged from memory. Thus, a restriction is placed on the number of connections that can take advantage of concatenation, so as to set a boundary on the overhead. Moreover, the concatenation delay can be reduced, since needless waitings for additional PDUs are reduced due to the restriction of concatenation to connections having a minimum level of activity.

Since the concatenation process is managed for all connections and all applications in one place, a better overall utilization of limited resources can be achieved. Additionally, application programs using the top-level communication layer are relieved from any concatenation duties.

Preferably, a connection is cancelled when the activity information thereof indicates an inactive connection for a predetermined time period. Thus, inactive connections are determined on the basis of the time period since the last transmission of a data packet of the connection. Thereby, the connections used in the concatenation procedure can be restricted to those connections, over which data packets are transmitted at least every predetermined time period. In this case, the activity information may comprise a timer information indicating a storing time of a data packet of the connection. The storing time may be defined by an expiry of a predetermined time period since the last transmission of the data packet.

Additionally, the activity information may comprise a counting information indicating the number of times the timer information has reached the predetermined time period. By providing the timer and counting information, a degree of inactivity of the connection can be determined on the basis of the counting information. Thereby, those connections having a large counting information can be allocated so as to be cancelled at a higher priority, when the memory means is full and a new connection is to be established.

Preferably, a maximum number of memory regions is provided for allocating connections which can be used for concatenation. Thereby, the maximum concatenation overhead can be restricted according to the maximum number of memory regions.

Each memory region may be used for storing the activity information and may comprise a buffer region for storing the received data packets. Thus, both the data packets and the activity information can be read from the same memory region, whereby processing overhead for controlling the allocation can be minimized.

Preferably, the memory region is an element of cache memory. Thereby, the allocation of the connection to the memory region can be performed such that inactive connections are placed at the end of the cache memory and active connections at the front of the cache memory. Thereby, inactive connections are automatically deleted from the cache memory, in case the cache is full and new connections are added.

In this case, the control processing may be based on a first pointer for indicating the first element of the cache memory, a second pointer for indicating the last element in the cache memory, and a third pointer for indicating an element between the first and the last element of the cache memory. These pointers can be used for allocating a connection to an element of the cache memory in accordance with the determined activity of the connection.

Therein, a connection can be allocated to an element defined by the third pointer, when the activity information indicates a low activity. Furthermore, a connection can be allocated to an element defined by the first pointer, when the activity information indicates a high activity. Additionally, a connection can be allocated to an element defined by the second pointer, when the activity information indicates an inactive connection. In this case, the element of the connection is cancelled from the cache memory, when a new element for a new connection is created and the connection is allocated to the last element of the cache memory.

The cache memory may be an array. In this case, a pointer information may be stored in the memory region, the pointer information pointing to a separate memory in which the activity information and the data packets received from the connection are stored. Thereby, inefficient copying and shifting of data in the array can be prevented, since only pointers to other memory structures are stored.

The predetermined time period may be adjusted based on a packet waiting time of the latest connection having the highest activity, based on an average of packet waiting times of all preceding connections having the highest activity, or based on a dynamic moving average of a packet waiting time of preceding connections. Thus, the timer can be dynamically adjusted to reflect the actual behavior of the connections, to thereby increase the benefits of concatenation.

### BRIEF DESCRIPTION OF THE DRAWINGS

In the following, the present invention will be described in greater detail on the basis of a preferred embodiment with reference to the accompanying drawings, in which:

FIG. 1 shows a principle block diagram of a concatenation apparatus according to the preferred embodiment of the present invention,

FIG. 2 shows a principle diagram of a cache memory used in the preferred embodiment of the present invention,

FIG. 3A shows time charts of input higher layer PDUs and output lower layer PDUs in a simplified example of the preferred embodiment of the present invention,

FIG. 3B shows a cache memory relating to the example shown in FIG. 3A,

FIG. 4 shows a flow diagram of a concatenation processing performed upon a generation of a new PDU in the preferred embodiment of the present invention, and FIG. 5 shows a flow diagram of a concatenation processing performed upon a timer expiration in the preferred embodiment of the present invention.

### DESCRIPTION OF THE PREFERRED EMBODIMENT

In the following, the preferred embodiment of the concatenation method and apparatus according to the present invention will be described.

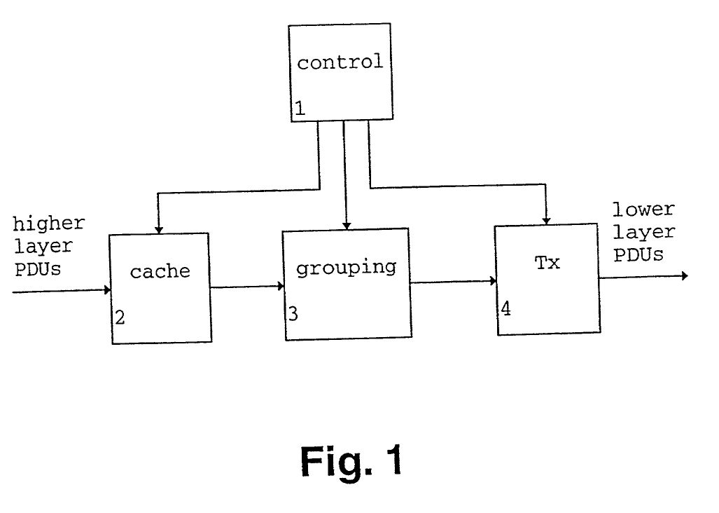

FIG. 1 shows a principle diagram of an apparatus for concatenating data packets, according to the preferred embodiment of the present invention. Such an apparatus can be comprised in any network element of a packet communication network, where data packets of different communication layers are to be concatenated.

According to FIG. 1, the concatenation apparatus comprises a memory such as a cache memory 2 for buffering PDUs received from a higher communication layer. The PDUs are stored in the cache memory 2 until they fill the size of a packet of a lower communication layer, or until a predetermined time period has expired. The stored higher layer PDUs are supplied to a grouping unit 3, where they are grouped or concatenated in order to generate PDUs of the lower communication layer. The generated lower layer PDUs are supplied to a transmitter arranged for transmitting the lower layer PDUs to a network element at another transmission end, where the lower layer PDUs are separated so as to obtain the original higher layer PDUs.

The concatenation handling and processing is controlled by a control unit 1 which may be arranged to control either one of the above cache memory 2, grouping unit 3 and transmitter 4. It is noted that the concatenation apparatus shown in FIG. 1 may be arranged as a hardware structure or as a software structure in which a central processing unit performs the concatenation handling and processing on the basis of corresponding software routines stored in a program memory.

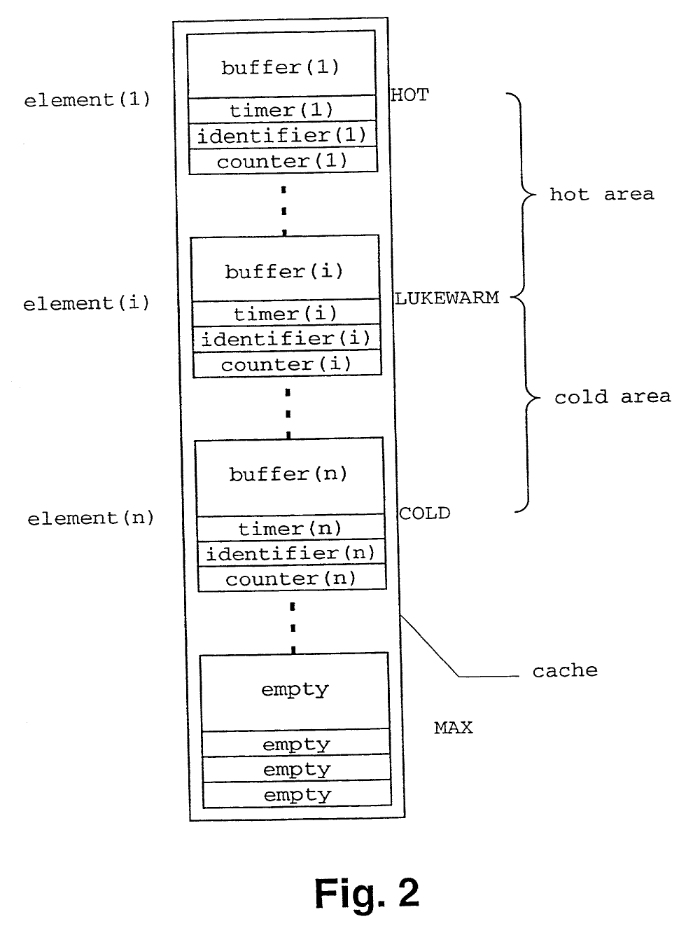

FIG. 2 shows a memory map of the cache memory 2 comprising a predetermined number of cache elements which can be used for storing higher layer PDUs in corresponding buffer areas provided in corresponding cache elements. According to FIG. 2, a maximum number MAX of connections can be used for the concatenation processing. In the case shown in FIG. 2, the cache memory is not fully used, since empty cache elements are provided in the lower portion of the cache memory. In each one of the actually used elements element(1) to element(n), a buffer buffer(1) to buffer(n) for PDUs to be concatenated, a timer value timer(1) to timer(n) indicating the expired time period or storing time since the last transmission of PDUs in the respective element, an identifier identifier(1) to identifier(n) of a connection allocated to the respective cache element, wherein the identifier may be a tuple <client address, client port number>, a session ID or the like, and a counter value counter(1) to counter(n) indicating the number of times the timer has reached a predetermined time period. Moreover, it is assumed that each cache element knows its rank in the cache.

For performing concatenation handling, the control means 1 defines a parameter MAX indicating the maximum number of connections to be used for concatenation, a pointer or index COLD which points to the last element of the cache memory, a pointer or index HOT which points to the first element of the cache memory, a pointer or index LUKEWARM which points to a cache element located between the first and the last element of the cache memory, a parameter default_timer indicating an initial predetermined time period set in the timer, a parameter max_timer-indicating the maximum time period to which the timer is set, and a parameter max_expirations defining the number of times the timer is allowed to expire without transmission of a PDU of a cache element.

Initially, the control means 1 performs settings such that HOT=COLD=LUKEWARM, default_timer=max_timer=any reasonable value (e.g. 2 seconds), max_expirations =any reasonable value (e.g. 4), MAX=any reasonable value that could correspond to the number of really active connections requiring concatenation at any point in time (e.g. 2048).

Essentially, the control means 1 performs concatenation handling and processing so as to manage a cache of connections that are deemed suitable for concatenation, wherein the above parameters are adapted dynamically so that active connections actually utilizing concatenation are kept in the cache, while other connections that do not need the concatenation feature are purged from the cache. This is achieved by placing information about connections, i.e. the received PDUs, the timer value, the identifier and the counter value, at suitable positions in the cache depending on their observed behavior, i.e. arrival of the PDUs to be concatenated, expiry of the timers and the like. Thus, the overall goal is to identify and quickly get rid of inactive and totally inactive connections, so that the cache memory contains only connections that can take advantage of concatenation.

The allocation between the connections and the cache elements is controlled by the control means 1 such that those connections which are somewhat active, i.e. new connections and connections whose timer expires but have something to send, are considered “lukewarm” and are moved towards or stay at a cache element defined by the pointer LUKEWARM. Furthermore, connections which are very active, i.e. those whose timer does not expire because there are always enough PDUs to fill a packet, are considered “hot” and are moved towards a hot area defined between the pointers HOT and LUKEWARM. Moreover, connections that are inactive, i.e. whose timer expires and which do not have anything to send, are considered “cold” and are moved quickly towards the cold area defined between the pointers LUKEWARM and COLD. Finally, connections that are totally inactive, i.e. whose timer has repeatedly expired such that the counter value has reached the parameter max_expirations without any transmission of a PDU, are eliminated from the cache memory.

Accordingly, inactive and totally inactive connections are allocated to a cold area and are thus quickly replaced by new connections, which are initially viewed as “lukewarm” and placed at a position defined by the pointer LUKEWARM.

If the number of hot connections increases or decreases, the pointer LUKEWARM is adjusted to reflect this fact. If all connections are considered “hot”, the pointer LUKEWARM corresponds to the pointer COLD.

When the cache is filled up by the control means 1, the pointer LUKEWARM increases together with the pointer COLD until it has reached a central point. Thereafter, it is adapted to the actual behavior of the connections.

Usually, connections go through phases of intensive communication separated by relative long periods of inactivity. In these situations, the connections are kept in the cache memory whenever they are active, and are then eliminated when they fall asleep. Thus, connections will keep going through a cycle of entering the cache, becoming “cold”, leaving it, and re-entering it again.

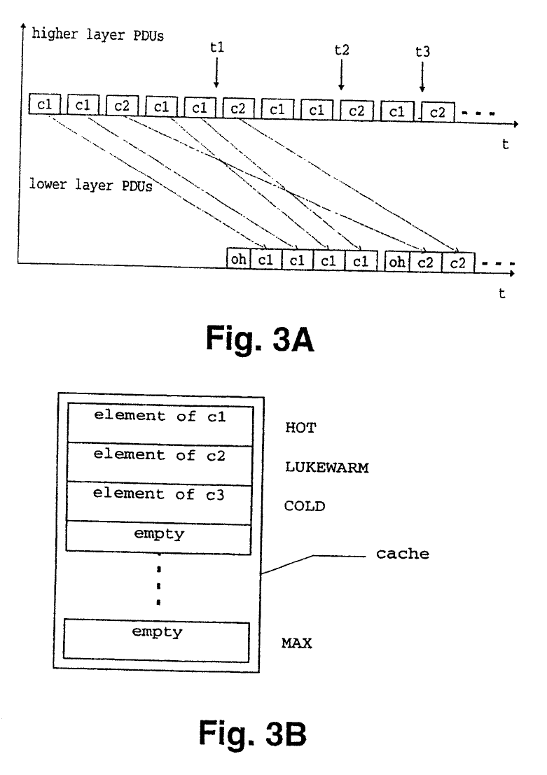

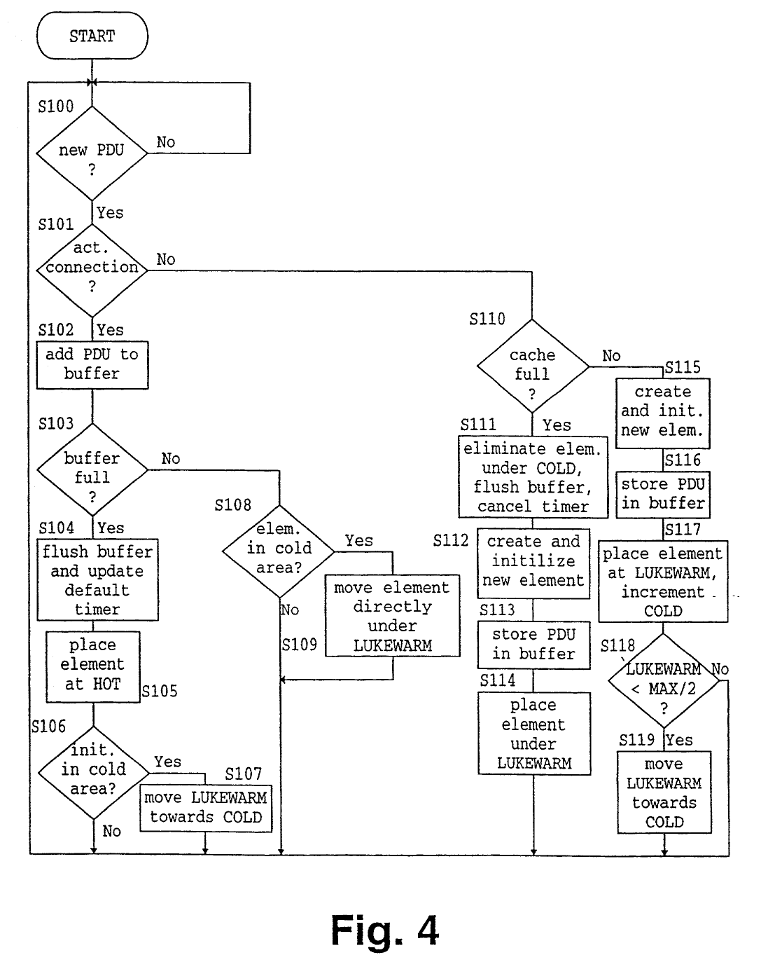

In the following, a simplified example of the preferred embodiment of the present invention is described on the basis of FIGS. 3A and 3B, wherein three connections c1 to c3 are subjected to the concatenation processing performed in the concatenation apparatus shown in FIG. 1.

In FIG. 3A, a first upper time chart is shown indicating received higher layer PDUs to be stored in the cache memory 2. Furthermore, a second lower time chart indicating transmitted lower layer PDUs which are transmitted by the transmitter 4. The higher layer PDUs are successively received from individual ones of the connections c1 to c3 and stored in the cache memory 2. The lower layer PDUs are generated in the grouping unit 3, when 4 higher layer PDUs have been stored in the cache memory 2, i.e. when the buffer of the respective cache element is full, or when the timer of the respective connection has expired.

According to FIG. 3A, the lower layer PDUs comprise an overhead portion oh and a payload consisting of four or less higher layer PDUs. In the present case, the first lower layer PDU is generated at the time t1 where the buffer of the cache element allocated to the connection c1 is full, i.e. after four higher layer PDUs of c1 have been received, as the timer of the connection c1 has not yet expired.

At the time t2, the timer of the connection c2 expires after two higher layer PDUs have been received and stored in the cache memory 2. Thus, a lower layer PDU is generated comprising two higher layer PDUs in its payload portion.

At the time t3, the timer of the connection c3 expires. However, since no higher layer PDU of the connection c3 has been received so far and stored in the cache memory 2, no lower layer PDU is generated and the counter value of the corresponding cache element of the connection c3 is incremented.

FIG. 3B shows the actual state of the cache memory 2 in the above described situation. Since the buffer of the connection c1 has been full before the expiry of the timer, the connection c1 is considered “hot” and allocated by the control means 1 to the first cache element indicated by the pointer HOT. The buffer of the connection c2 was not empty at the time of the expiry of the timer of the connection c2, such that the connection c2 is considered “lukewarm” and allocated to the second position of the cache memory to which the pointer LUKEWARM points. Finally, the connection c3 is allocated to the last element of the cache memory, i.e. the position indicated by the pointer COLD, since it is judged as an inactive or “cold” connection. Thus, the position of the allocated element in the cache memory reflects the activity of the corresponding connection.

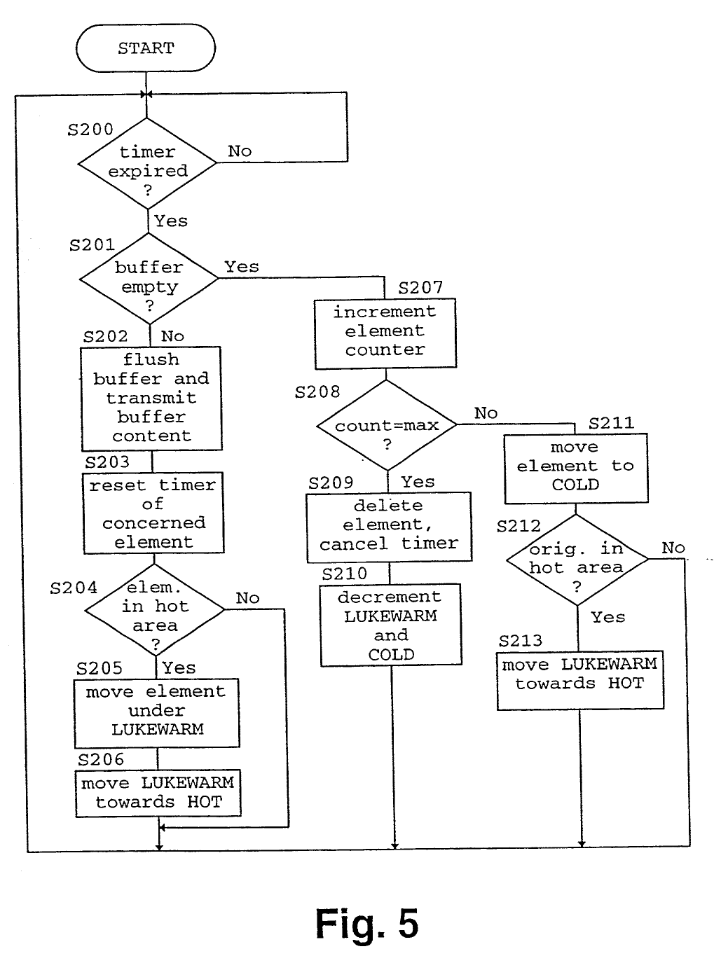

In the following, the concatenation handling and processing performed by the control unit 1 is described in greater detail on the basis of the flow diagrams shown in FIGS. 4 and 5.

Essentially, two events have to be handled by the control unit 1 after the initialization of the parameters and pointers, i.e. the receipt of a higher layer PDU and the expiration of a timer.

FIG. 4 shows a flow diagram of the control procedure performed upon receipt of a new higher layer PDU. According to FIG. 4, the control means 1 initially checks in step S100 whether a new PDU has been received. If not, the control procedure remains in a waiting loop until a new PDU has been received. If a new PDU has been received, it is checked in step S101 whether the new PDU corresponds to a connection which is already active, i.e. whether a corresponding connection identifier can be found in the cache memory. If an active connection has been determined in step S101, the new PDU is added to the buffer of the respective cache element (step S102). Then, it is determined in step S103, whether the buffer has become full by adding the new PDU. If the buffer has become full, the buffer is flushed in step S104, i.e. the whole block of PDUs contained in the buffer is supplied to the grouping unit 3 and subsequently transmitted by the transmitter 4. Furthermore, the default timer is updated based on the waiting time of the buffer in the cache. Since a full buffer has been detected, the allocation of the connection is changed by placing the respective element at the front of the cache memory 2, i.e. under HOT (S105).

Thereafter, it is determined in step S106 whether the element was initially located between the pointers LUKEWARM and COLD. If so, the position of the pointer LUKEWARM is moved one position towards the pointer COLD (S107), such that the hot area grows.

If the buffer has not become full in step S103, it is determined in step S108 whether the element of the connection is located between the pointers LUKEWARM and COLD. If so, the allocation of the connection is changed such that the element is moved directly to a position corresponding to the pointer LUKEWARM (S109).

If it is determined in step S1O1 that the new PDU corresponds to a new connection, i.e. the connection identifier could not be found in the cache memory 2, it is determined in step S110 whether the cache memory 2 is full, i.e. whether the number of cache elements corresponds to the parameter MAX. If so, the cache element allocated under COLD is eliminated, the corresponding buffer is flushed, if necessary, and the timer is canceled (S111). Then, a new element is created, its timer is initialized to the parameter default—timer, its identifier is initialized according to the identifier of the new connection, and its counter value is set to zero (step S112). Furthermore, the received new PDU is put into the buffer of the new element (S113) and the resulting new element is placed at a position defined by the pointer LUKEWARM.

If the cache is determined to be not full in step S110, i.e. the cache contains less than its maximum number of cache elements, a new element is created and initialized as described in step S111 (S115). Furthermore, the received new PDU is stored in the buffer of the new element (S117), and the new element is placed at a position defined by the pointer LUKEWARM (S117). Subsequently, it is determined in step S118 whether the pointer LUKEWARM points to a position below the center of the cache memory 2 (LUKEWARM<MAX/2). If so, the pointer LUKEWARM is moved one position towards the pointer COLD which itself has been incremented one position in step S117 due to the insertion of the new element.

After the above described respective branches of the flow diagram have been processed, the procedure returns to step S100 in order to wait for a new PDU.

FIG. 5 shows a flow diagram of the control procedure performed in case of the second event, i.e. if one of the timers of the cache elements has expired. In step S200, it is determined whether a timer has been expired, i.e. whether its time period has reached the parameter max—timer. If not, the procedure stays in a waiting loop until the expiry of a timer has been detected.

If one of the timers has expired, it is determined in step S201 whether the buffer of the element corresponding to the expired timer is empty. If the buffer of the element is not empty, the buffer is flushed and its content is grouped and transmitted in a lower layer PDU (S202). Then, the timer of the concerned element is reset (S203). Thereafter, it is determined in step S204 whether the element was placed between LUKEWARM and HOT, i.e. in the hot area. If so, the allocation of the connection is changed so as to move the element under LUKEWARM (S205). Furthermore, the pointer LUKEWARM is moved one position towards the pointer HOT such that the hot area shrinks.

If the buffer of the concerned element is empty in step S201, the counter value of the respective element is incremented (S207), and it is then checked in step S208, whether the counter value equals the parameter max_expirations. If so, the element is deleted due to the total inactivity of the connection allocated thereto, and the timer is cancelled (S209). Furthermore, the pointers LUKEWARM and COLD are decremented by one, since the number of elements has decreased.

If the counter value is smaller then the parameter max_expirations, the concerned element is moved from its current position to COLD (S211), due to the inactive connection allocated thereto. Then, it is checked in step S212 whether the concerned element was originally placed between HOT and LUKEWARM. If so, the pointer LUKEWARM is moved one position towards the pointer HOT, such that the hot area shrinks.

After processing of the above described branches of the flow diagram, the procedure returns to step S200 in order to wait for the expiry of a timer.

It is noted, that the flow diagrams shown in FIGS. 4 and 5 may be combined in an obvious manner to form a single diagram, wherein the checking operations concerning the expiry of one of the timers and the receipt of a new PDU are included in a single waiting loop.

As an alternative, the above concatenation approach can be simplified by fixing the pointer LUKEWARM to an arbitrary value, e.g. MAX/2, and not adjusting it.

The cache memory 2 may be implemented as an array, wherein the pointers LUKEWARM, COLD and HOT are indices defining respective array positions, or as a linked list, wherein the above pointers point to respective elements in the list. However, the array may be inconvenient in that moving or inserting elements requires potentially inefficient copying and shifting of data in the array. The same applies to a certain degree to the linked list. This inconvenience can be aleviated somehow by storing only pointers to other memory structures, such as externally allocated structures, since copying pointers requires less processing power than copying entire structures comprising PDU buffers, counter values, timer values and identifiers.

As to the relocation of elements, a fine tuning is possible by moving the elements by one position instead of placing them directly at specific LUKEWARM COLD or HOT positions. This alternative would slow down the movement of really active connections towards the hot area and really inactive connections towards the cold area.

As already described in step S104 of FIG. 4, the parameter default_timer can be dynamically adjusted so as to reflect the actual behavior of the connections, whereby the benefits of the concatenation can be increased. In particular, the parameter default_timer can be modified in accordance with the actual waiting period of connections, which defines the time period until their buffers are full before the expiration of their timers.

The dynamic adjustment of the parameter default_timer may be performed by assigning the waiting time of the latest hot connection as the parameter default_timer. Alternatively, an average of all past hot connections can be assigned as the parameter default_timer, which requires computing and updating the average for the entire lifetime of the cache memory 2. As a further alternative, the parameter default_timer can be assigned on the basis of a function of past connections with a dynamic moving average, for example

default_timerₜ=α·wait_timeₜ₋₁+(1−α)·default_timerₜ₋₁,

wherein 0 <α<1, default_timer₀=max_timer, and wait_timeₜ₋₁ denotes the waiting time of a past connection defined by the respective index t−1. However, in any case, the parameter default_timer may not exceed the parameter max_timer.

It is to be noted that the above description of the preferred embodiment and the accompanying drawings are only intended to illustrate the present invention. The preferred embodiment of the present invention may thus vary within the scope of the attached claims.

In summary, a method and apparatus for concatenating data packets in a communication protocol is described, wherein a connection to be used for concatenation is allocated to a memory region based on which data packets received from said connection are stored in order to be concatenated. Furthermore, an activity information of the connection is provided, wherein the allocation of the connection is changed on the basis of the activity information. Thus, a cache of connections which are deemed suitable for concatenation can be managed by shifting and cancelling the memory regions allocated to the connection so that active connections which actually utilize concatenation are kept in the cache, while other connections which do not need the concatenation feature are purged from the cache. Thereby, a restriction can be placed on the number of connections that can take advantage of the concatenation, so as to limit the overhead produced by the concatenation feature.

1. A method for concatenating data packets in a communication protocol, comprising the steps of:
a) allocating a connection to be used for concatenation to a memory region;
b) storing data packets received from said connection on the basis of said allocation;
c) providing an activity information of said connection; and
d) changing the allocation of said connection on the basis of said activity information.

2. A method according to claim 1, wherein said connection is canceled, when said activity information indicates an inactive connection for a predetermined time period.

3. A method according to claim 1 or 2, wherein said activity information comprises a timer information indicating a storing time of a data packet of said connection.

4. A method according to claim 3, wherein said activity information comprises a counting information indicating the number of times said timer information has reached a predetermined time period.

5. A method according to any one of the preceeding claims, wherein a maximum number of memory regions is provided for allocating connections which can be used for concatenation.

6. A method according to any one of the preceeding claims, wherein said memory region is used to store said activity information and comprises a buffer region for storing said received data packets.

7. A method according to any of the preceeding claims, wherein an identification information for identifying said connection is stored in said memory region.

8. A method according to claim 4, wherein a predetermined value of said counting information is used to indicate an inactive connection.

9. A method according to any one of the preceeding claims, wherein said memory region is an element of a cache memory.

10. A method according to claim 9, wherein a pointer information is stored in said memory region, said pointer information pointing to a separate memory in which said activity information and said data packets received from said connection are stored.

11. A method according to claim 9 or 10, wherein a first pointer is provided for indicating the first element of said cache memory, a second pointer for indicating the last element of said cache memory, and a third pointer for indicating an element between said first and last element of said cache memory.

12. A method according to claim 11, wherein said connection is allocated to an element defined by said third pointer, when said activity information indicates a low activity.

13. A method according to any one of claims 9 to 12, wherein said connection is allocated to an element defined by said first pointer, when said activity information indicates a high activity.

14. A method according to any one of claims 9 to 13, wherein said connection is allocated to an element defined by said second pointer, when said activity information indicates an inactive connection.

15. A method according to any one of claims 9 to 14, wherein said element of said connection is cancelled from said cache memory, when said connection has been allocated to the last element of said cache memory and a new element for a new connection is created.

16. A method according to any one of claims 9 to 15, wherein said cache memory is an array.

17. A method according to any one of claims 2 to 16, wherein said predetermined time period is adjusted based on a packet waiting time of the latest connection having the highest activity.

18. A method according to any one of claims 2 to 16, wherein said predetermined time period is adjusted based on an average of packet waiting times of all preceding connections having the highest activity.

19. A method according to any one of claims 2 to 16, wherein said predetermined time period is adjusted based on a dynamic moving average of a packet waiting time of preceding connections.

20. An apparatus for concatenating data packets in a communication protocol, comprising:
a) memory means (2) having a plurality of memory regions;
b) control means (1) for allocating a connection to one of said plurality of memory regions, said one of said plurality of memory regions being used for concatenating data packets of said connection; and
c) providing means (1) for providing an activity information of said connection,
d) wherein said control means (1) is arranged to change the allocation of said connection based on said activity information.

21. An apparatus according to claim 20, wherein a timer is provided for indicating an expiry of a predetermined storing time of a data packet of said connection, and wherein said activity information comprises a timer value of said timer.

22. An apparatus according to claim 21, wherein a counter is provided for counting the number of times said timer has reached said predetermined time period, and wherein said activity information comprises a count value of said counter.

23. An apparatus according to any one of claims 20 to 22, wherein said memory means is a cache memory (2) and wherein said memory region is an element of said cache memory (2).

24. An apparatus according to any one of claims 20 to 23, wherein said control means (1) is arranged to control said memory means (2) so as to store said data packets of said connection and said activity information in said one of said plurality of memory regions.

25. An apparatus according to any one of claims 20 to 23, wherein said control means (1) is arranged to control said memory means (2) so as to store a pointer information in said one of said plurality of memory regions, said pointer information pointing to a memory region of another memory means, in which said data packets of said connection and said activity information are stored.

26. An apparatus according to claim 22, wherein said control means (1) is arranged to cancel said connection, when said counter has reached a predetermined counter value.
